(19) United States
(12) Patent Application Publication
(10) Pub. No.: US 2019/0114713 A1
(43) Pub. Date: Apr. 18, 2019

(54) REAL-TIME BENEFIT ELIGIBILITY EVALUATION

(71) Applicant: Accenture Global Solutions Limited, Dublin (IE)

(72) Inventors: Bogdan E. Sacaleanu, Dublin (IE); Pedro Sacristan, Dublin (IE); Urvesh Bhowan, Bray (IE)

(21) Appl. No.: 15/783,082

(22) Filed: Oct. 13, 2017

(51) Int. Cl. G06Q 40/08; G06F 7/02

(52) U.S. Cl. CPC G06Q 40/08; G06F 7/026

(57) ABSTRACT

Implementations are directed to computer-implemented, real-time benefit eligibility evaluation including actions of receiving a request in a computer-readable format, the request indicating a procedure, a policy, and providing metadata, and determining that a sufficiently similar request has not been previously received, and at least partially in response: providing a set of policies, determining similarity scores between the policy, and each policy in the set of policies to provide a set of similarity scores, identifying a most similar policy in the set of policies based on similarity scores in the set of similarity scores, and outputting a decision to the request, the decision including a historical decision previously output for the most similar policy.

### BACKGROUND

In the healthcare context, patients are covered by policies that align covered procedures (e.g., medical procedures covered by the policy) with conditions (e.g., doctor-diagnosed conditions). In some instances, a doctor treats the patient with a procedure, and the policy is reviewed in hindsight for coverage of the treatment. It can occur that a treatment is not covered by a policy, and additional costs/resources are consumed resolving this issue after the fact. In some instances, a doctor submits a recommended procedure to a policy provider, which evaluates the procedure in view of the policy and provides a decision as to whether the policy covers the procedure. This, however, can take days or weeks, resulting in delays in treating patients.

### SUMMARY

Implementations of the present disclosure are generally directed to benefit eligibility evaluation. More particularly, implementations of the present disclosure are directed to real-time benefit eligibility evaluation based on historical policy decisions.

In some implementations, actions include receiving a first request in a computer-readable format, the first request indicating a first procedure, a first policy, and providing metadata, and determining that a sufficiently similar request has not been previously received, and at least partially in response: providing a set of policies, determining similarity scores between the first policy, and each policy in the set of policies to provide a set of similarity scores, identifying a most similar policy in the set of policies based on similarity scores in the set of similarity scores, and outputting a first decision to the first request, the first decision including a historical decision previously output for the most similar policy. Other implementations of this aspect include corresponding systems, apparatus, and computer programs, configured to perform the actions of the methods, encoded on computer storage devices.

These and other implementations can each optionally include one or more of the following features: determining similarity scores includes, for at least one policy in the set of policies, comparing blocks included in the first policy, determining, for each block, respective similarity sub-scores, and providing the similarity score based on the similarity sub-scores; determining similarity scores includes, for at least one policy in the set of policies determining that the first procedure is included in the at least one policy, and providing a similarity score as equal to an upper bound; policies in the set of policies include policies, for which a same request as the first request had been previously received; actions further include receiving a second request in a computer-readable format, and determining that a sufficiently similar request had been previously received, and at least partially in response, outputting a second decision to the second request, the second decision including a historical decision previously output for the sufficiently similar request; and first decision includes only one of an accept decision, and a deny decision.

The present disclosure also provides a computer-readable storage medium coupled to one or more processors and having instructions stored thereon which, when executed by the one or more processors, cause the one or more processors to perform operations in accordance with implementations of the methods provided herein.

The present disclosure further provides a system for implementing the methods provided herein. The system includes one or more processors, and a computer-readable storage medium coupled to the one or more processors having instructions stored thereon which, when executed by the one or more processors, cause the one or more processors to perform operations in accordance with implementations of the methods provided herein.

It is appreciated that methods in accordance with the present disclosure can include any combination of the aspects and features described herein. That is, methods in accordance with the present disclosure are not limited to the combinations of aspects and features specifically described herein, but also include any combination of the aspects and features provided.

The details of one or more implementations of the present disclosure are set forth in the accompanying drawings and the description below. Other features and advantages of the present disclosure will be apparent from the description and drawings, and from the claims.

### BRIEF DESCRIPTION OF DRAWINGS

FIG. 1 depicts an example high-level architecture in accordance with implementations of the present disclosure.

FIG. 2 depicts an example module architecture in accordance with implementations of the present disclosure.

FIGS. 3A and 3B depict an example process that can be executed in accordance with implementations of the present disclosure.

### DETAILED DESCRIPTION

Implementations of the present disclosure are generally directed to benefit eligibility evaluation. More particularly, implementations of the present disclosure are directed to real-time benefit eligibility evaluation based on historical policy decisions. As described in further detail herein, implementations of the present disclosure include actions of receiving a request in a computer-readable format, the request indicating a procedure, a policy, and providing metadata, and determining that a sufficiently similar request has not been previously received, and at least partially in response: providing a set of policies, determining similarity scores between the policy, and each policy in the set of policies to provide a set of similarity scores, identifying a most similar policy in the set of policies based on similarity scores in the set of similarity scores, and outputting a decision to the request, the decision including a historical decision previously output for the most similar policy.

In general, the present disclosure is directed to a platform for real-time evaluation of benefit eligibility for procedures in view of patient-specific policies. The platform can implement a standard medical language taxonomy, such as that provided in the Unified Medical Language System (UMLS), which includes terminology, classification and coding standards for procedures, conditions, and treatments. The platform can make a determination as to whether a policy covers a procedure by comparing a current request to historical requests. For example, a historical decision knowledgebase is provided and records allow/deny decisions (e.g., A/D decisions) for respective policies and procedures.

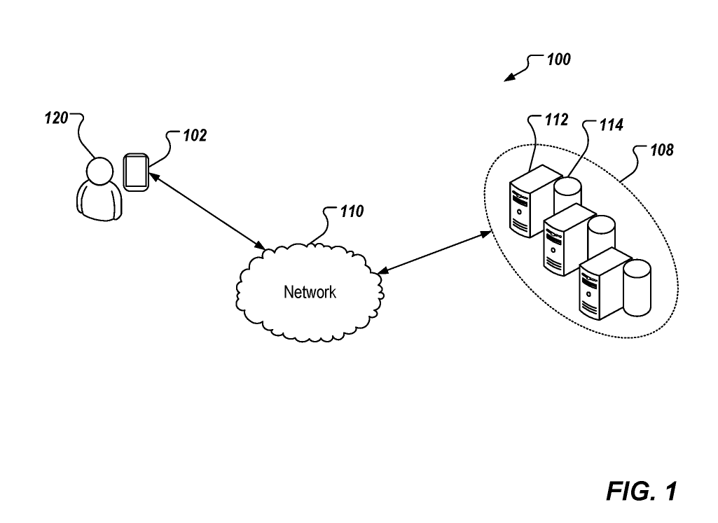

FIG. 1 depicts an example high-level architecture 100 in accordance with implementations of the present disclosure. The example architecture 100 includes a device 102, a server system 108, and a network 110. In some examples, the network 110 includes a local area network (LAN), wide area network (WAN), the Internet, a cellular telephone network, a public switched telephone network (PSTN), a private branch exchange (PBX), a next generation network (NGN), or any appropriate combination thereof, and connects web sites, devices (e.g., the device 102), and server systems (e.g., the server system 108). In some examples, the network 110 can be accessed over a wired and/or a wireless communications link. For example, mobile devices, such as smartphones can utilize a cellular network to access the network 110.

In the depicted example, the server system 108 includes at least one server system 112, and data store 114 (e.g., database). In some examples, at least one server system 112 hosts one or more computer-implemented services that users can interact with using devices. For example, the server system 112 can host an AI-based digital agent in accordance with implementations of the present disclosure. In some examples, the device 102 can each include any appropriate type of computing device such as a desktop computer, a laptop computer, a handheld computer, a tablet computer, a personal digital assistant (PDA), a cellular telephone, a network appliance, a camera, a smartphone, a telephone, a mobile phone, an enhanced general packet radio service (EGPRS) mobile phone, a media player, a navigation device, an email device, a game console, or an appropriate combination of any two or more of these devices, or other data processing devices.

In accordance with the present disclosure, the server system 108 can host a real-time benefit eligibility evaluation service, which receives data, and benefit eligibility requests, as described herein. For example, a healthcare provider (e.g., a user 120 in FIG. 1), at a point-of-care, can electronically submit a request, and any underlying documentation (e.g., in computer-readable format) to the benefit eligibility evaluation service using a computing device (e.g., the computing device 102). The benefit eligibility evaluation service processes the information to selectively render a decision (e.g., back to the user 120) on whether a requested procedure is covered under a respective policy. In this manner, the healthcare provider can receive a response in real-time, avoiding unnecessary delays in treating a patient.

In accordance with the present disclosure, a user (e.g., a healthcare provider) can submit a request for real-time benefit eligibility evaluation. As used herein, real-time describes actions that can be automatically executed, without requiring human input and without any intentional delay, taking into account the processing limitations of the benefit eligibility evaluation system, and any time required to process data. In some implementations, the request identifies a patient having a policy (P), the request being submitted for approval for a procedure (Pr) to be performed for the patient. The benefit eligibility system outputs a decision (D) for the request, the decision indicating whether the procedure is approved (e.g., whether the procedure is covered under the patient's policy).

In some examples, the request is received as a scanned document. For example, a physical document detailing the request (e.g., a request submission form) can be scanned-in to be provided as a computer-readable, and transmittable electronic document. In some examples, the electronic document is processed to enable metadata (recorded in text) to be read from the electronic document (e.g., processed using optical character recognition (OCR)). In some implementations, the request is processed to extract relevant metadata from the electronic document. Example metadata can include, without limitation, a patient identifier (PAT_{ID}) (e.g., an identifier that uniquely identifies a patient within a population), demographic information (e.g., gender, age), a policy (P) associated with the patient (e.g., the policy defining procedures, treatments, and the like that are covered under the policy), a procedure (Pr) that is being requested for the patient, and a diagnosis associated with the patient (e.g., disease, injury, and the like that the procedure is being requested to treat).

The benefit eligibility evaluation system compares the current request to one or more historical requests stored in a knowledgebase. In some examples, if the current request does not sufficiently match one or more historical requests (e.g., indicating that the current request is unique), the request can be forwarded for manual review, and decision making by one or more agents. In some examples, the result of such manual review(s) can be recorded in a knowledgebase for comparison to future requests.

In some implementations, if the current request sufficiently matches one or more historical requests, a set of policies (e.g., one or more policies P₁, . . . , Pₙ) associated with each historical request is returned. In some examples, similarity between requests can be determined based on a match between procedures, and other information (e.g., demographic information, diagnosis). For example, the historical requests can be reviewed to identify a set of historical requests (e.g., one or more historical requests) that include the same procedure, which is the subject of the current request. For each historical request in the set of historical requests, other information (e.g., demographic information, diagnosis) is compared to respective information of the current request to determine a similarity therebetween. If the other information is sufficiently similar, the current request and a historical request are determined to match. For each historical request that is determined to be similar to the current request, one or more policies associated with the historical request, and respective decisions made on each of the policies, are returned, and are included in the set of policies.

In some examples, similarity between the other information (e.g., demographic information, diagnosis) can be determined using cosine similarity. For example, respective multi-dimensional vectors can be provided for the current request, and each of the historical requests, and the vector for the current request can be compared to each of the vectors of the historical requests. In some examples, respective dot products can be determined between the vector of the current requests, and each of the vectors of the historical requests to provide respective similarity scores. In some examples, if a similarity score exceeds a threshold similarity score, the respective historical request is determined to be sufficiently similar to the current request, and one or more policies associated with the historical request, and respective decisions made on each of the policies, are included in the set of policies.

In accordance with implementations of the present disclosure, each policy in the set of policies is compared with the policy underlying the current request to identify the same policy, or most similar historical policy (i.e., a policy in the set of policies that is most similar to the policy underlying the current request). In some implementations, the decision provided for the same policy, or the most similar historical policy is provided as the output for the current request.

In some implementations, the set of policies is searched to determine whether the set of policies already includes the policy underlying the current request. That is, whether a request for the same policy, and procedure, is already included in the set of policies. If there is a direct match, the decision for the matching historical policy is provided as the output. If, however, there is not a direct match, the set of policies is reviewed to identify similar policies.

In some implementations, comparing each of the historical policies to the current policy results in respective similarity scores to provide a set of similarity scores. In some examples, a maximum similarity score in the set of similarity scores is identified, and the historical policy associated with the maximum similarity score is determined to be the most similar policy. A decision associated with that historical policy is provided as the output for the current request. If, however, multiple historical policies have the same, maximum similarity score, the most recent decision as between the multiple historical policies is provided as the output. For example, if a first policy and a second policy have the same similarity score, which is the maximum similarity score, timestamps of respective decisions of the first policy and the second policy are determined, and the decision having the most recent timestamp is provided as the output.

In some examples, the maximum similarity score can be compared to a threshold similarity score. If the maximum similarity score does not exceed the threshold similarity score, it can be determined that none of the historical policies is sufficiently similar. Consequently, the request can be forwarded for manual processing.

In some implementations, comparison of the current policy to each of the historical policies is conducted on a block-by-block basis based on medical concepts, and terminology to identify common blocks. In further detail, each policy can include a plurality of blocks, each block including text associated with medical concepts, and terminology. Example medical concepts can include, without limitation, procedures, treatments, conditions, diagnosis, and the like. Example terminology can include, without limitation, in-patient care, outpatient care, daily care, and the like. In some examples, concepts and/or terminology are provided from one or more authoritative resources (e.g., the UMLS).

In some implementations, similar blocks between policies are identified. In some examples, blocks of different policies having the same medical concepts, and/or terminology are determined to be similar blocks (also referred to as common blocks, as both policies have the blocks in common). In some examples, if the procedure underlying the current request is included in a block of a historical policy, the similarity score for that historical policy is set to an upper bound (e.g., the historical policy and the current policy are determined to be identical, at least with respect to the procedure). In some examples, the similarity score can range between the upper bound (e.g., 1), and a lower bound (e.g., 0).

If, however, the procedure underlying the current request is not included in a block of a historical policy, the similarity score for that historical policy is determined based on the concepts, and/or terminology. In some examples, a delta between the current policy, and the historical policy is determined. For example, the delta represent differences between the policies in terms of blocks provided in one policy, but not provided in the other policy. In some examples, similarity sub-scores can be determined for blocks in the delta based on processing the concepts, and/or terminology recorded in the respective deltas. Processing can include natural language processing (NLP), such as textual entailment. In some examples, textual entailment between blocks results in a similarity sub-score that represents a likelihood of a text fragment in one block being true based on a text fragment in another block.

Accordingly, a set of similarity sub-scores can be provided for all blocks included in the delta. In some implementations, the similarity sub-scores are combined to provide a similarity score as between the current policy and the respective policy being considered. The similarity sub-scores can be combined using any appropriate technique(s) (e.g., weighted sum, weighted average, normalization), and can be provided in a range defined between the upper bound, and the lower bound. Similarity score determination is repeated for all policies in the set of policies to provide the set of similarity scores.

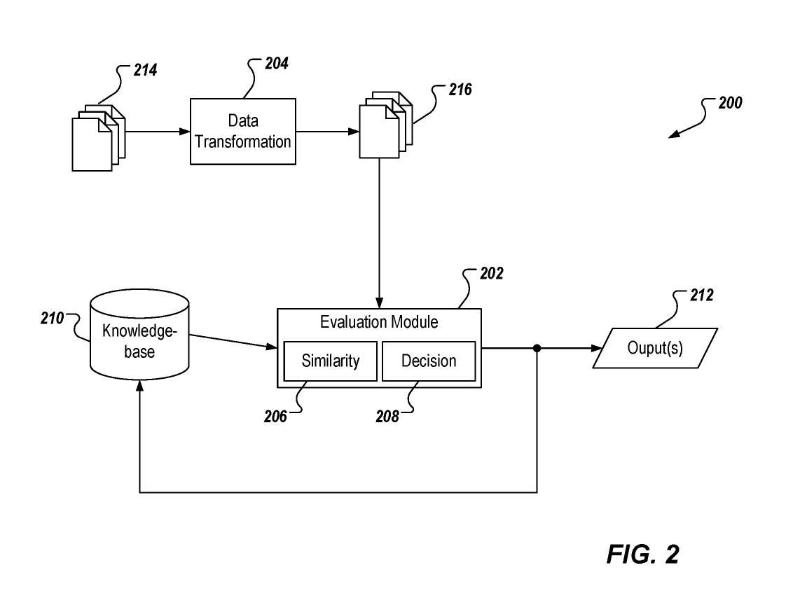

FIG. 2 depicts an example module architecture 200 in accordance with implementations of the present disclosure. In the depicted example, the module architecture 200 includes an evaluation module 202, and a data transformation module 204. The evaluation module 202 includes a similarity sub-module 206, and a decision sub-module 208. In some examples, each of the modules, and/or sub-modules can be provided by one or more computer-executable programs that are executed by one or more computing devices (e.g., of the back-end system 108 of FIG. 1). The example module architecture 200 also includes a knowledgebase 210. In accordance with implementations of the present disclosure, the evaluation module 202 executes benefit eligibility evaluations based on respective requests, and data recorded in the knowledgebase to provide respective benefit eligibility decisions as one or more outputs 212.

In some implementations, a request is received by the module architecture 200. In some examples, the request includes one or more electronic documents 214. Each of the electronic documents is provided in a computer-readable format (e.g., portable document format (PDF)). Example electronic documents can include, without limitation, historical medical records (e.g., medical charts, EMRs, medical texts). In some examples, physical sources, such as physical medical records, or charts can be converted to digital data to be provided as an electronic document 212. In some examples, an electronic document can include an electronic copy of a physical document (e.g., a physical document scanned in to an electronic document). In some examples, the data transformation module 204 processes the electronic documents 212 to provide input documents 216 in a standardized format. An example standardized format includes a text format (e.g., .TXT). For example, an electronic document provided as a PDF file, can be used to provide an input document as a TXT file using optical character recognition (OCR) executed over the electronic document.

In some examples, the input documents 214 are processed to remove any personally identifiable information (PII). Example PII can include, without limitation, name, address, and social security number (SSN). It is contemplated, however, that demographic information, if any, remain in the input documents 214. Example demographic information can include, without limitation, age, gender, and race.

In some implementations, the evaluation module 202 processes one or more of the input documents 214 to determine metadata associated with the request for benefit eligibility evaluation. In some implementations, the similarity sub-module 206 processes the metadata to determine whether a similar request (R) had been previously received (e.g., historical request), as described herein. If the current request does not sufficiently match one or more historical requests (e.g., indicating that the current request is unique), the request can be forwarded for manual review, and decision making by one or more agents. For example, the similarity sub-module 206 provides a signal to the decision sub-module, and, in response, the decision sub-module 208 provides an output 212 indicating manual intervention. In some examples, the evaluation module 202 can transmit the request, and any relevant information (e.g., the input documents) to a computing device of a manual reviewer. In some examples, the result of such manual review(s) can be recorded in the knowledgebase 210 for comparison to future requests.

As described herein, if the current request sufficiently matches one or more historical requests, a set of policies associated with each historical request is returned (e.g., from the knowledgebase 210). The similarity sub-module 206 compares each policy in the set of policies with the policy underlying the current request to identify the most similar historical policy, as described herein. In some examples, the decision sub-module 208 provide the decision associated with the most similar historical policy as the output 212 for the current request. As also described herein, if the similarity score of the most similar historical policy is below the threshold similarity score, it can be determined that none of the historical policies is sufficiently similar. Consequently, the request can be forwarded for manual processing. In some examples, the evaluation module 202 can transmit the request, and any relevant information (e.g., the input documents) to a computing device of a manual reviewer.

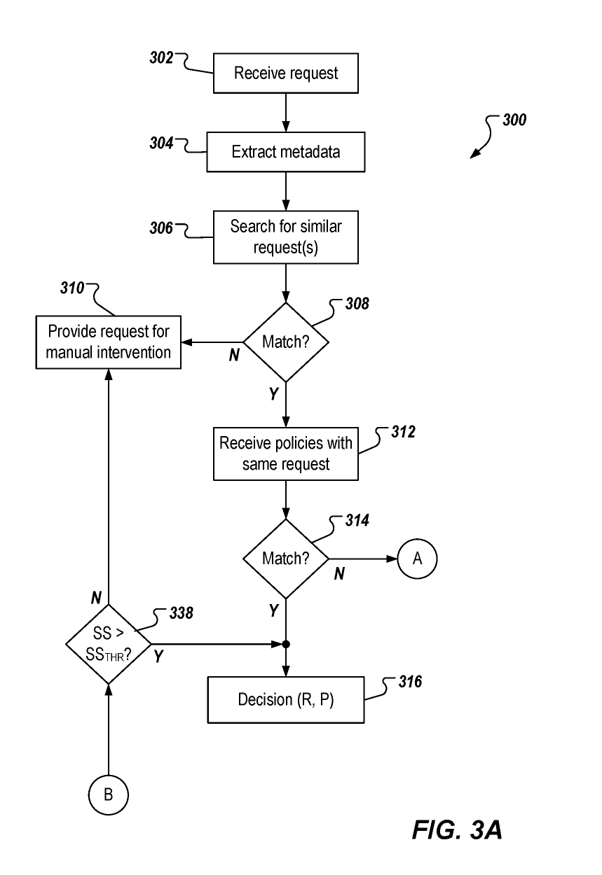

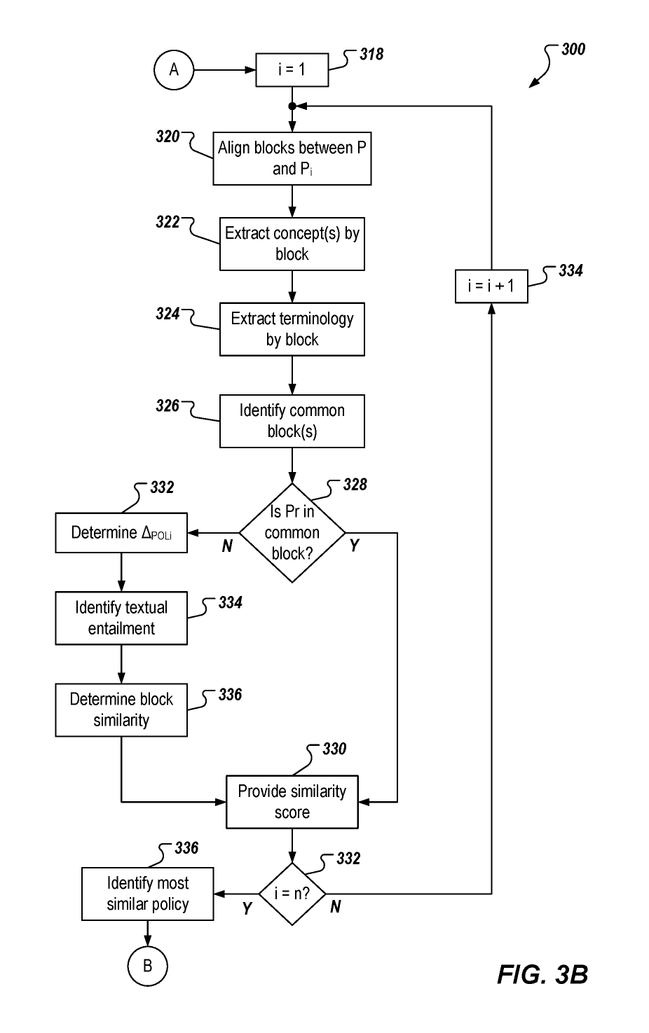

FIGS. 3A and 3B depict an example process 300 that can be executed in implementations of the present disclosure. In some examples, the example process 300 is provided using one or more computer-executable programs executed by one or more computing devices (e.g., the server system 108 of FIG. 1).

A request is received (302). For example, a request (R) for a benefit eligibility determination is received by the evaluation module 202 of FIG. 2. In some examples, at least a portion of the request is included in the input documents 214 received by the evaluation module 202. Metadata is extracted for the request (304). For example, and as described above, the evaluation module 202 extracts a patient identifier (PAT_{ID}) (e.g., an identifier that uniquely identifies a patient within a population), demographic information (e.g., gender, age), a policy (P) associated with the patient (e.g., the policy defining procedures, treatments, and the like that are covered under the policy), a procedure (Pr) that is being requested for the patient, and a diagnosis associated with the patient (e.g., disease, injury, and the like that the procedure is being requested to treat).

A search for similar requests is performed (306). For example, the similarity sub-module 206 compares the request and metadata to historical requests and respective metadata (e.g., provided from the knowledgebase 210) to identify one or more similar requests, as described herein. It is determined whether any similar requests exist (308). If no similar request is present, the request is provided for manual intervention (310). If one or more similar requests are present, policies associated with the request(s) are received (312). For example, the evaluation module 202 receives a set of policies from the knowledgebase 210. It is determined whether there is a policy match (314). More particularly, it is determined whether there is a direct match between the policy underlying the current request, and a policy in the set of policies. If there is a direct match, the decision that had been provided for the historical policy is provided as output in response to the request (316). If there is not a direct match, policies in the set of policies are reviewed for similarity to the policy underlying the current request.

A counter i is set equal to 1 (318). Blocks between the policy (P) underlying the current request, and a historical policy (Pᵢ), are aligned (320). On a block-by-block basis, concepts are extracted (322), and terminology is extracted (324). As between the policy P and the policy Pᵢ, common blocks are identified (326). It is determined whether the procedure (Pr), which is the subject of the current request, is included in a common block (328). If the procedure is included in a common block, a similarity score is provided (330). For example, the similarity score is set equal to an upper bound (e.g., 1). If the procedure is not included in a common block, a similarity score of the policy Pᵢ is determined based on block similarities. That is, a delta (Δ_{POLi}) between the policy P, and the policy Pᵢ is determined (332), textual entailment is performed for each block in the delta (334), block similarity sub-scores are determined (336), and a similarity score is provided (330), as described herein.

It is determined whether the counter i is equal to n (332). That is, it is determined whether all policies in the set of policies have been considered. If the counter i is not equal to n, the counter i is incremented, and the example process 300 loops back. If the counter i is equal to n, the most similar historical policy is identified (336). For example, the highest similarity score is determined, and the historical policy having the highest similarity score is identified as the most similar policy in the set of policies. The similarity score (SS) of the most similar policy is compared to a threshold similarity score (SS_{THR}) (338). If the similarity score does not exceed the threshold similarity score, the request is provided for manual intervention (310). If the similarity score exceeds the threshold similarity score, the decision rendered for the most similar historical policy is returned as the decision for the current request.

Implementations and all of the functional operations described in this specification may be realized in digital electronic circuitry, or in computer software, firmware, or hardware, including the structures disclosed in this specification and their structural equivalents, or in combinations of one or more of them. Implementations may be realized as one or more computer program products, i.e., one or more modules of computer program instructions encoded on a computer readable medium for execution by, or to control the operation of, data processing apparatus. The computer readable medium may be a machine-readable storage device, a machine-readable storage substrate, a memory device, a composition of matter effecting a machine-readable propagated signal, or a combination of one or more of them. The term “computing system” encompasses all apparatus, devices, and machines for processing data, including by way of example a programmable processor, a computer, or multiple processors or computers. The apparatus may include, in addition to hardware, code that creates an execution environment for the computer program in question (e.g., code that constitutes processor firmware, a protocol stack, a database management system, an operating system, or any appropriate combination of one or more thereof). A propagated signal is an artificially generated signal (e.g., a machine-generated electrical, optical, or electromagnetic signal) that is generated to encode information for transmission to suitable receiver apparatus.

A computer program (also known as a program, software, software application, script, or code) may be written in any appropriate form of programming language, including compiled or interpreted languages, and it may be deployed in any appropriate form, including as a stand alone program or as a module, component, subroutine, or other unit suitable for use in a computing environment. A computer program does not necessarily correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program may be deployed to be executed on one computer or on multiple computers that are located at one site or distributed across multiple sites and interconnected by a communication network.

The processes and logic flows described in this specification may be performed by one or more programmable processors executing one or more computer programs to perform functions by operating on input data and generating output. The processes and logic flows may also be performed by, and apparatus may also be implemented as, special purpose logic circuitry (e.g., an FPGA (field programmable gate array) or an ASIC (application specific integrated circuit)).

Processors suitable for the execution of a computer program include, by way of example, both general and special purpose microprocessors, and any one or more processors of any appropriate kind of digital computer. Generally, a processor will receive instructions and data from a read only memory or a random access memory or both. Elements of a computer can include a processor for performing instructions and one or more memory devices for storing instructions and data. Generally, a computer will also include, or be operatively coupled to receive data from or transfer data to, or both, one or more mass storage devices for storing data (e.g., magnetic, magneto optical disks, or optical disks). However, a computer need not have such devices. Moreover, a computer may be embedded in another device (e.g., a mobile telephone, a personal digital assistant (PDA), a mobile audio player, a Global Positioning System (GPS) receiver). Computer readable media suitable for storing computer program instructions and data include all forms of non-volatile memory, media and memory devices, including by way of example semiconductor memory devices (e.g., EPROM, EEPROM, and flash memory devices); magnetic disks (e.g., internal hard disks or removable disks); magneto optical disks; and CD ROM and DVD-ROM disks. The processor and the memory may be supplemented by, or incorporated in, special purpose logic circuitry.

To provide for interaction with a user, implementations may be realized on a computer having a display device (e.g., a CRT (cathode ray tube), LCD (liquid crystal display) monitor) for displaying information to the user and a keyboard and a pointing device (e.g., a mouse, a trackball, a touch-pad), by which the user may provide input to the computer. Other kinds of devices may be used to provide for interaction with a user as well; for example, feedback provided to the user may be any appropriate form of sensory feedback (e.g., visual feedback, auditory feedback, tactile feedback); and input from the user may be received in any appropriate form, including acoustic, speech, or tactile input.

Implementations may be realized in a computing system that includes a back end component (e.g., as a data server), a middleware component (e.g., an application server), and/or a front end component (e.g., a client computer having a graphical user interface or a Web browser, through which a user may interact with an implementation), or any appropriate combination of one or more such back end, middleware, or front end components. The components of the system may be interconnected by any appropriate form or medium of digital data communication (e.g., a communication network). Examples of communication networks include a local area network (“LAN”) and a wide area network (“WAN”), e.g., the Internet.

The computing system may include clients and servers. A client and server are generally remote from each other and typically interact through a communication network. The relationship of client and server arises by virtue of computer programs running on the respective computers and having a client-server relationship to each other.

While this specification contains many specifics, these should not be construed as limitations on the scope of the disclosure or of what may be claimed, but rather as descriptions of features specific to particular implementations. Certain features that are described in this specification in the context of separate implementations may also be implemented in combination in a single implementation. Conversely, various features that are described in the context of a single implementation may also be implemented in multiple implementations separately or in any suitable sub-combination. Moreover, although features may be described above as acting in certain combinations and even initially claimed as such, one or more features from a claimed combination may in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems may generally be integrated together in a single software product or packaged into multiple software products.

A number of implementations have been described. Nevertheless, it will be understood that various modifications may be made without departing from the spirit and scope of the disclosure. For example, various forms of the flows shown above may be used, with steps re-ordered, added, or removed. Accordingly, other implementations are within the scope of the following claims.

What is claimed is:

1. A method for computer-implemented benefit eligibility evaluation, the method being performed by one or more processors, and comprising:
receiving, by the one or more processors, a first request in a computer-readable format, the first request indicating a first procedure, a first policy, and providing metadata; and
determining, by the one or more processors, that a sufficiently similar request has not been previously received, and at least partially in response:
providing a set of policies;
determining similarity scores between the first policy, and each policy in the set of policies to provide a set of similarity scores;
identifying a most similar policy in the set of policies based on similarity scores in the set of similarity scores; and
outputting a first decision to the first request, the first decision comprising a historical decision previously output for the most similar policy.

2. The method of claim 1, wherein determining similarity scores comprises, for at least one policy in the set of policies, comparing blocks included in the first policy, determining, for each block, respective similarity sub-scores, and providing the similarity score based on the similarity sub-scores.

3. The method of claim 1, wherein determining similarity scores comprises, for at least one policy in the set of policies determining that the first procedure is included in the at least one policy, and providing a similarity score as equal to an upper bound.

4. The method of claim 1, wherein policies in the set of policies comprise policies, for which a same request as the first request had been previously received.

5. The method of claim 1, further comprising:
receiving a second request in a computer-readable format; and
determining that a sufficiently similar request had been previously received, and at least partially in response, outputting a second decision to the second request, the second decision comprising a historical decision previously output for the sufficiently similar request.

6. The method of claim 1, wherein the first decision comprises only one of an accept decision, and a deny decision.

7. One or more non-transitory computer-readable storage media coupled to one or more processors and having instructions stored thereon which, when executed by the one or more processors, cause the one or more processors to perform operations for computer-implemented benefit eligibility evaluation, the operations comprising:
receiving a first request in a computer-readable format, the first request indicating a first procedure, a first policy, and providing metadata; and
determining that a sufficiently similar request has not been previously received, and at least partially in response:
providing a set of policies;
determining similarity scores between the first policy, and each policy in the set of policies to provide a set of similarity scores;
identifying a most similar policy in the set of policies based on similarity scores in the set of similarity scores; and
outputting a first decision to the first request, the first decision comprising a historical decision previously output for the most similar policy.

8. The computer-readable storage media of claim 7, wherein determining similarity scores comprises, for at least one policy in the set of policies, comparing blocks included in the first policy, determining, for each block, respective similarity sub-scores, and providing the similarity score based on the similarity sub-scores.

9. The computer-readable storage media of claim 7, wherein determining similarity scores comprises, for at least one policy in the set of policies determining that the first procedure is included in the at least one policy, and providing a similarity score as equal to an upper bound.

10. The computer-readable storage media of claim 7, wherein policies in the set of policies comprise policies, for which a same request as the first request had been previously received.

11. The computer-readable storage media of claim 7, wherein operations further comprise:
receiving a second request in a computer-readable format; and
determining that a sufficiently similar request had been previously received, and at least partially in response, outputting a second decision to the second request, the second decision comprising a historical decision previously output for the sufficiently similar request.

12. The computer-readable storage media of claim 7, wherein the first decision comprises only one of an accept decision, and a deny decision.

13. A system, comprising:
one or more processors; and
a computer-readable storage device coupled to the one or more processors and having instructions stored thereon which, when executed by the one or more processors, cause the one or more processors to perform operations for computer-implemented benefit eligibility evaluation, the operations comprising:
receiving a first request in a computer-readable format, the first request indicating a first procedure, a first policy, and providing metadata; and
determining that a sufficiently similar request has not been previously received, and at least partially in response:
providing a set of policies;
determining similarity scores between the first policy, and each policy in the set of policies to provide a set of similarity scores;
identifying a most similar policy in the set of policies based on similarity scores in the set of similarity scores; and
outputting a first decision to the first request, the first decision comprising a historical decision previously output for the most similar policy.

14. The system of claim 13, wherein determining similarity scores comprises, for at least one policy in the set of policies, comparing blocks included in the first policy, determining, for each block, respective similarity sub-scores, and providing the similarity score based on the similarity sub-scores.

15. The system of claim 13, wherein determining similarity scores comprises, for at least one policy in the set of policies determining that the first procedure is included in the at least one policy, and providing a similarity score as equal to an upper bound.

16. The system of claim 13, wherein policies in the set of policies comprise policies, for which a same request as the first request had been previously received.

17. The system of claim 13, wherein operations further comprise:
receiving a second request in a computer-readable format; and
determining that a sufficiently similar request had been previously received, and at least partially in response, outputting a second decision to the second request, the second decision comprising a historical decision previously output for the sufficiently similar request.

18. The system of claim 13, wherein the first decision comprises only one of an accept decision, and a deny decision.
